(19) United States
(12) Patent Application Publication
(10) Pub. No.: US 2021/0059469 A1
(43) Pub. Date: Mar. 4, 2021

(54) One Kind of Machine for Fume Removal

(71) Applicant: Sandora Household Electric Appliances (Shenzhen) Ltd, Bao'an District (CN)

(72) Inventors: Kowk Wai Wong, Hong Kong (HK); Wai Hang Louie, Hong Kong (HK); Marko Walter Unger, Bao'an District (CN); Kachun Lee, Hong Kong (HK); Kakit Yee, Hong Kong (HK); Lokhang Keung, Hong Kong (HK); Kingho So, Hong Kong (HK)

(21) Appl. No.: 16/946,380

(22) Filed: Jun. 18, 2020

Related U.S. Application Data
(63) Continuation of application No. PCT/CN2019/107636, filed on Sep. 25, 2019.

(30) Foreign Application Priority Data
Aug. 30, 2019 (CN) 201921431435.6

(51) Int. Cl. A47J 36/38; A47J 37/07

(52) U.S. Cl. CPC A47J 36/38; A47J 37/0786; A47J 37/0754

(57) ABSTRACT

The present utility model discloses an oil-smoke removal device, including an oil-smoke removal device body, which is provided with an air inlet at one end, and an air outlet at the other end, and an absorption and decomposition device for decomposing and absorbing the oil-smoke is provided in the middle of the oil-smoke removal device body. The oil-smoke removal device provided by the present utility model is a structure mainly applied for absorbing oil-smoke during barbecue, and it uses the absorption and decomposition device in the structure to achieve the objective of effective adsorption and decomposition of the oil-smoke contained in the oil-smoke gas, which greatly reduces the environmental pollution caused by oil-smoke emissions, resulting in a very good effect in the practical application.

### CROSS-REFERENCE TO RELATED APPLICATION(S)

This application is a Continuation of PCT Patent Application Serial No. PCT/CN2019/107636, filed on Sep. 25, 2019 for “One Kind of Machine for Fume Removal”, which claims benefit of Chinese Patent Application Serial No. CN 201921431435.6, filed on Aug. 30, 2019 for “One Kind of Machine for Fume Removal”, the entire disclosures of which are incorporated herein by references.

### TECHNICAL FIELD

The present utility model relates to the technical field of barbecue oil-smoke removal devices, and specifically to an oil-smoke removal device.

### BACKGROUND

In recent years, as environmental issues have become increasingly prominent, there is a significant increase in harmful particles such as MP10 and MP2.5 in air, which has brought great harm to human health. Because of the unique cooking methods of China, oil-smoke produced by the cooking method accounts for a large proportion of the harmful particles that are emitted, and other production lifestyles [sic] such as burning wood and burning straw also produce harmful particles. In the existing technical methods, oil-smoke is only removed by installing a range hood, but most of the oil-smoke is still discharged into the air to cause damage to the environment. As a result, there is a problem in the existing technical methods in that it is difficult to remove the oil-smoke.

Therefore, the prior art needs to be improved and developed.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### SUMMARY

Given the inadequacies of the above-mentioned prior art, an objective of the present utility model is to provide a device that is capable of simply and effectively removing barbecue oil-smoke.

In order to solve the above technical problem, the present utility model has adopted the following technical solutions:

An oil-smoke removal device, comprising an oil-smoke removal device body, which is provided with an air inlet at one end, and an air outlet at the other end, and an absorption and decomposition device for decomposing and absorbing the oil-smoke being provided in the middle of the oil-smoke removal device body.

The oil-smoke removal device, wherein a fan is also provided in the middle of the oil-smoke removal device body, the fan is disposed at the rear of the air inlet, and the absorption and decomposition device is located on both sides of the fan.

The oil-smoke removal device, wherein a UV-A ultraviolet lamp for activating the absorption and decomposition device is provided above or below the absorption and decomposition device.

The oil-smoke removal device, wherein the absorption and decomposition device is a photocatalytic mixture material of at least one layer.

The oil-smoke removal device, wherein the absorption and decomposition device is fixed in set to both sides of the fan by a fixing device.

The oil-smoke removal device, wherein the oil-smoke removal device body further comprises a stack disposed at the front end of the fan.

The oil-smoke removal device, wherein one end of the stack is connected to the fan, and the other end of the stack is close to but not contacting a barbecue platform.

The oil-smoke removal device, wherein the photocatalytic mixture material is provided with two layers, and the UV-A ultraviolet lamp is disposed in the middle of the photocatalytic mixture material.

The oil-smoke removal device, wherein the photocatalytic mixture material comprises a non-combustible absorbent and a photocatalytic material doped in the non-combustible absorbent.

The oil-smoke removal device, wherein the photocatalytic material comprises titanium dioxide.

The oil-smoke removal device, wherein the photocatalytic material further comprises one or more selected from the group consisting of silver ions, zinc ions, copper ions, and manganese ions.

The oil-smoke removal device, wherein the oil-smoke removal device further comprises a bracket disposed below the oil-smoke removal device.

The oil-smoke removal device, wherein one end of the bracket is connected to the oil-smoke removal device and the other end is detachably connected to the barbecue platform.

A barbecue device comprising a barbecue platform, wherein the oil-smoke removal device as described in any one of the above is provided on the barbecue platform.

A barbecue oven, comprising an oven body for placing and processing barbecue materials and an oven lid coupled to the oven body, wherein the oil-smoke absorption and decomposition device as described above is provided on the oven lid.

The barbecue oven, wherein the oven lid and the oven body can be opened and closed to any angle and fixed.

The barbecue oven, wherein the maximum opening and closing angle between the oven body and the oven lid is 180°.

An oil-smoke adsorption rack, comprising a platform for producing oil-smoke and a frame on the platform, wherein the oil-smoke absorption and decomposition device as described above is provided on an inner side of the frame.

The oil-smoke adsorption rack, wherein the frames are distributed side by side on the platform.

The oil-smoke adsorption rack, wherein the distance between the frames is not more than 10 mm.

In comparison to the prior art, the present utility model discloses an oil-smoke removal device, including an oil-smoke removal device body, which is provided with an air inlet at one end, and an air outlet at the other end, and an absorption and decomposition device for decomposing and absorbing the oil-smoke is provided in the middle of the oil-smoke removal device body. The present utility model is a structure mainly applied for absorbing oil-smoke during barbecue, and it uses the oil-smoke absorption and decomposition device in the structure to achieve the goal of effective adsorption and decomposition of the oil-smoke contained in the oil-smoke gas, which greatly reduces the environmental pollution caused by oil-smoke emissions, resulting in a very good effect in the practical application.

### BRIEF DESCRIPTION OF THE DRAWINGS

Various aspects of apparatuses and methods will now be presented in the detailed description by way of example, and not by way of limitation, with reference to the accompanying drawings, wherein:

FIG. 1 is an exploded schematic view of an oil-smoke removal device provided by the present utility model.

FIG. 2 is a schematic view of a barbecue device provided by the present utility model.

FIG. 3 is a schematic view of a closed state of a barbecue oven provided by the present utility model on a barbecue grill.

FIG. 4 is a schematic view of a closed state of the barbecue oven provided by the present utility model.

FIG. 5 is a schematic diagram of an open state of the barbecue oven provided by the present utility model.

FIG. 6 is a side cross-sectional view of the barbecue oven provided by the present utility model.

FIG. 7 is a side cross-sectional view from another angle of the barbecue oven provided by the present utility model.

FIG. 8 is an exploded view of an oven lid of the barbecue oven provided by the present utility model.

FIG. 9 is a side cross-sectional view of the oven lid of the barbecue oven provided by the present utility model.

### DETAILED DESCRIPTION

In order to make the objective, technical solutions and advantages of the present utility model clearer, the present utility model will be further described in detail below with reference to the attached drawings and embodiments. It should be understood that the specific embodiments described herein are used only to explain the present utility model and not to limit the present utility model.

It is important to note that when a component is referred to as “mounted on”, “fixed to” or “provided on” another component, it may be directly present on another component or there may be an intermediate component at the same time. When a component is referred to as “connected to” another component, it can be directly connected to another component or there may be an intermediate component at the same time.

It is also required to note that the left, right, upper, lower, and other positional terms in the embodiments of the present utility model are only concepts relative to each other or reference to a normal use state of the product, and should not be considered restrictive.

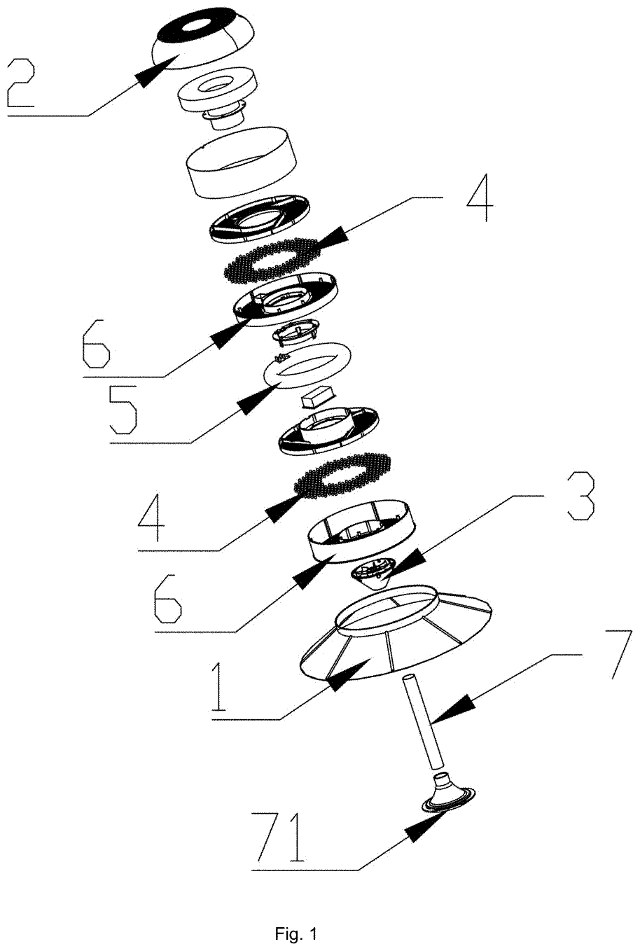

The present embodiment of the present utility model provides an oil-smoke removal device, referring to FIG. 1, which includes an oil-smoke removal device body, which is provided with an air inlet on one end and an air outlet on the other end, an absorption and decomposition device 4 for decomposing and absorbing oil-smoke being provided in the middle of the oil-smoke removal device body.

In the present embodiment, the generated oil-smoke enters the oil-smoke removal device body through the air inlet, and the absorption and decomposition device 4 provided in the middle of the oil-smoke removal device can rapidly and efficiently decompose and absorb the oil-smoke. Further, the gas from which the oil-smoke has been removed is discharged from the air outlet 2. It is a simple structure with high absorption and decomposition efficiency.

Further, a fan 3 is provided in the middle of the oil-smoke removal device body. The fan 3 is disposed at the rear of the air inlet 1, and the absorption and decomposition device 4 is positioned on both sides of the fan 3. In order to ensure that the oil-smoke is removed sufficiently, optionally, the fan 3 is used to absorb the generated oil-smoke into the oil-smoke removal device body, thereby further improving the oil-smoke decomposition rate.

Further, a UV-A ultraviolet lamp 5 for activating the absorption and decomposition device 4 is provided above or below the absorption and decomposition device 4, and the oil-smoke absorption and decomposition device 4 can be activated by ultraviolet ray generated by the UV-A ultraviolet lamp 5, thereby further enhancing the oil-smoke removal efficiency.

Further, the absorption and decomposition device 4 is a photocatalytic mixture material of at least one layer.

In the present embodiment, the photocatalytic mixture material in the oil-smoke absorption and decomposition device 4 can be activated by the ultraviolet ray generated by the UV-A ultraviolet lamp 5 provided above or below the oil-smoke absorption and decomposition device 4. The oil-smoke gas entering from the air inlet 1 can be decomposed and removed by the activated photocatalytic mixture material, and the gas from which the oil-smoke has been removed can be discharged from the air outlet 2, thereby achieving the objective of removing the oil-smoke contained in the oil-smoke gas, which greatly reduces the environmental pollution caused by oil-smoke emissions, resulting in a very good effect in the practical application.

Continuing to refer to FIG. 1, the absorption and decomposition device 4 is fixed in set to both sides of the fan 3 by a fixing device 6, which is more beneficial for absorption and decomposition of the oil-smoke, and is also faster and more convenient to replace.

Further, the oil-smoke removal device body 1 further includes a stack 7 disposed at the front end of the fan 3. The stack 7 can absorb all of the oil-smoke into the oil-smoke removal device body by using the suction of the fan 3, which further guarantees the totality and quickness of the oil-smoke removal.

Further, one end of the stack 7 is coupled to the fan 3, and the other end of the stack 7 is close to but not contacting a barbecue platform 8. In order to better absorb and decompose all the oil-smoke, one end of the stack 7 is coupled to the fan 3, and optionally, the other end may also be provided with an external structure 71 that is close to but not contacting the barbecue platform 8, which effectively solves the drawback of insufficient absorption of oil-smoke.

In the present embodiment, the oil-smoke removal device is provided above the barbecue platform 8. When the user barbecues on the barbecue platform 8, a large amount of oil-smoke will be generated. First, the fan 3 works and rotates to generate suction to the outside, and collects and absorbs through the passage of the stack 7 the large amount of oil-smoke generated when the user barbecues on the barbecue platform 8. When the oil-smoke is absorbed into the oil-smoke removal device body, the ultraviolet ray generated by the UV-A ultraviolet lamp 5 activates the photocatalytic material in the photocatalytic mixture material. When the oil-smoke is absorbed into the oil-smoke removal device body, the activated photocatalytic material absorbs and decomposes the oil-smoke to achieve the objective of removing oil-smoke. The gas from which the oil-smoke has been removed is discharged from the air outlet 2 under the action of the fan 3, which greatly reduces the environmental pollution caused by oil-smoke emissions, resulting in a very good effect in the practical application.

In a further embodiment, continuing to refer to FIG. 1, there are two layers of the photocatalytic mixture material, and the UV-A ultraviolet lamp 5 is disposed in the middle of the photocatalytic mixture material to better and more effectively remove the oil-smoke. Optionally, the photocatalytic mixture material may also be provided with two layers, and the UV-A ultraviolet lamp 5 may be provided between the two layers of photocatalytic mixture material to activate the photocatalytic mixture material at the same time, which improves the activation efficiency and the efficiency of oil-smoke removal.

In a further embodiment, referring to FIG. 1, the photocatalytic mixture material comprises a non-combustible absorbent 41 and a photocatalytic material 42 doped in the non-combustible absorbent 41, and the photocatalytic material 42 may be activated under a condition of illumination of the UV-A ultraviolet lamp 5 or under a temperature condition of 200° C. or lower.

Specifically, after the oil-smoke in the oil-smoke gas entering from the air inlet 1 is absorbed by the non-combustible absorbent 41, the oil-smoke is further decomposed and removed by the activated photocatalytic material 42, and the gas from which the oil-smoke has been removed may be discharged from the air outlet 2.

In a further embodiment, the non-combustible absorbent 41 is selected from any one of zeolite or activated alumina. As the oil-smoke discharged from the kitchen has a higher temperature, in order to avoid combustion of the oil-smoke when encountering air at a high temperature, it is preferable in the present embodiment that the non-combustible absorbent 41 is formed from materials such as zeolite and activated alumina, and the shape of the non-combustible absorbent 41 is round or cylindrical particles.

In a further embodiment, the photocatalytic mixture material 4 [sic: 42] comprises a non-combustible absorbent and titanium dioxide doped in the non-combustible absorbent.

In a further embodiment, the photocatalytic mixture material 4 [sic: 42] comprises a non-combustible absorbent, titanium dioxide that is doped in the non-combustible absorbent, and one or more selected from the group consisting of silver ions, zinc ions, copper ions, and manganese ions. In the present embodiment, the titanium dioxide and one or more selected from the group consisting of silver ions, zinc ions, copper ions and manganese ions can be used together as a catalyst for oil-smoke decomposition. The titanium dioxide and the silver ions, zinc ions, copper ions and manganese ions can have a synergistic effect after activation, thereby effectively enhancing the catalytic performance thereof and improving the decomposition efficiency of the oil-smoke.

In a further embodiment, the oil-smoke removal device further comprises a bracket 9 disposed below the oil-smoke removal device, wherein one end of the bracket 9 is connected to the oil-smoke removal device, and the other end is detachably connected to the barbecue platform 8.

Specifically, the connection between the oil-smoke removal device and the barbecue platform 8 may also be that the bracket 9 is provided below the oil-smoke removal device, and when in use, the other end of the bracket 9 is directly inserted below the barbecue platform 8. In this connection mode, the oil-smoke removal device is closer to the barbecue platform 8, and thus the stack 7 may not be needed. At the same time, if the distance is closer, the fan 3 and the UV-A ultraviolet lamp 5 may not be needed. This is because, in the present embodiment, the photocatalytic material 42 can be activated under the illumination condition of the UV-A ultraviolet lamp 5, or can be activated under the temperature condition of 200° C. or lower.

Further, the length of the bracket 9 may be set as desired, and the shape of the bracket 9 may also be varied. The present embodiment adopts an L-shaped structure. Of course, in other embodiments, a C-shaped structure or a T-shaped structure may also be used, as long as it can achieve the connection function. The shapes and structures of the fan 3 and the UV-A ultraviolet lamp 5 may also be set as desired, which improves efficiency and simplifies the structure.

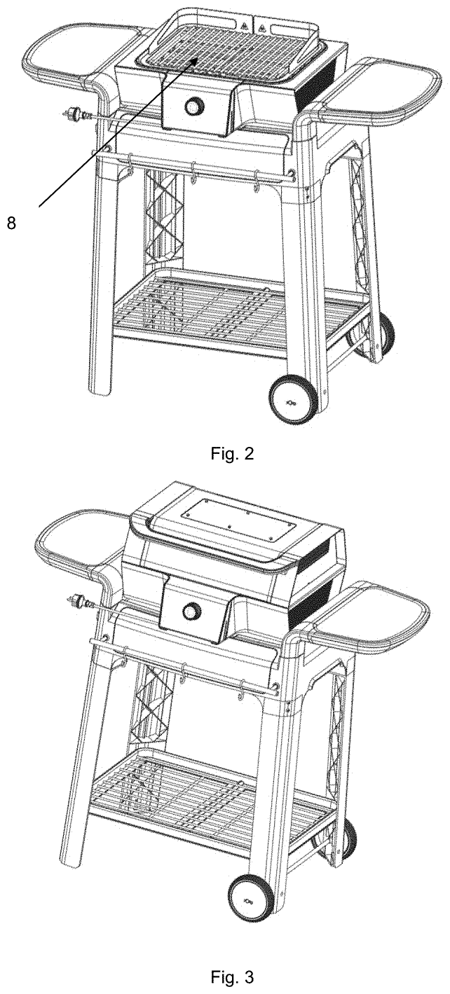

Referring to FIGS. 2 and 3, the present utility model also provides a barbecue device, which includes a barbecue platform 8 on which the oil-smoke removal device as described above is provided.

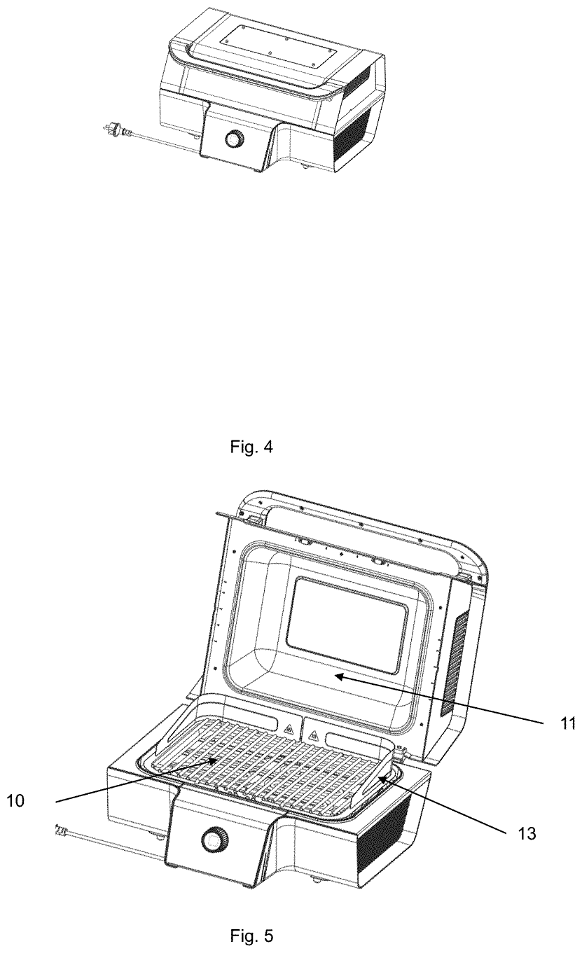

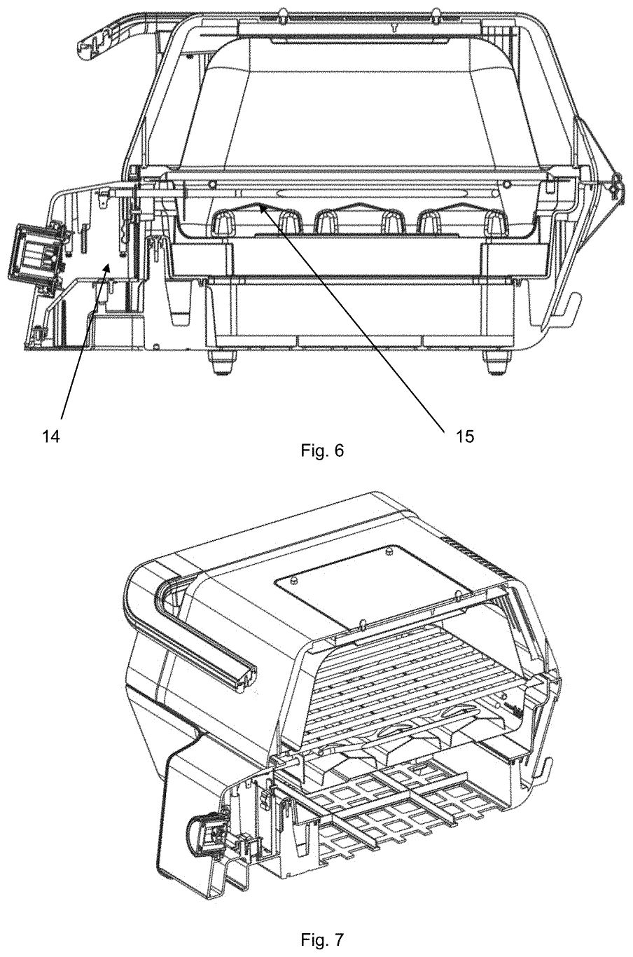

Referring to FIGS. 4 to 7, the present utility model also provides a barbecue oven, including an oven body 10 for placing and processing barbecue materials, and an oven lid 11 that is coupled to the oven body 10, wherein the oil-smoke absorption and decomposition device (not shown) as described above is provided on the oven lid 11. A windshield 13 is provided on one of the sides of the oven body 10, which can better prevent the oil-smoke from being blown to other places when it rises.

In the present embodiment, the oven body further includes a control box 14 and a reflection plate 15 positioned inside the oven body 10. The control box 14 can control the heating temperature at will, and there are three groups of reflection plates 15, which can effectively raise the heating temperature. Since the oven body 10 is coupled with the oven lid 11 and the temperature of the oven lid 11 is not higher than 200° C., the photocatalytic material 42 can be automatically activated, and the UV-A ultraviolet lamp 5 is not needed to assist activation. It also improves efficiency, simplifies the structure, and adds flexibility and convenience.

Further, the oven lid 11 and the oven body 10 can be opened and closed to any angle and fixed, allowing the user to determine the degree of the oven lid opening and closing according to his/her own needs, which is flexible. It is possible to select the degree of opening and closing when the oil-smoke is heavy or light, thereby effectively achieving the removal of the oil-smoke.

Further, the maximum opening and closing angle between the oven body 10 and the oven lid 11 is 180°. The oven body 10 and the oven lid 11 are utilized to the maximum extent. When there are many materials to be barbecued and the area of the barbecue oven is insufficient, the oven body 10 and the oven lid 11 can be rotated to 180°, then the oil-smoke absorption and decomposition device 4 in the oven lid 11 is removed and [the oven lid 11 is] directly used as a barbecue platform, and then an oil-smoke removal device provided by the present embodiment is provided on this barbecue platform, which effectively uses space and achieves the effect of multiple uses with one oven.

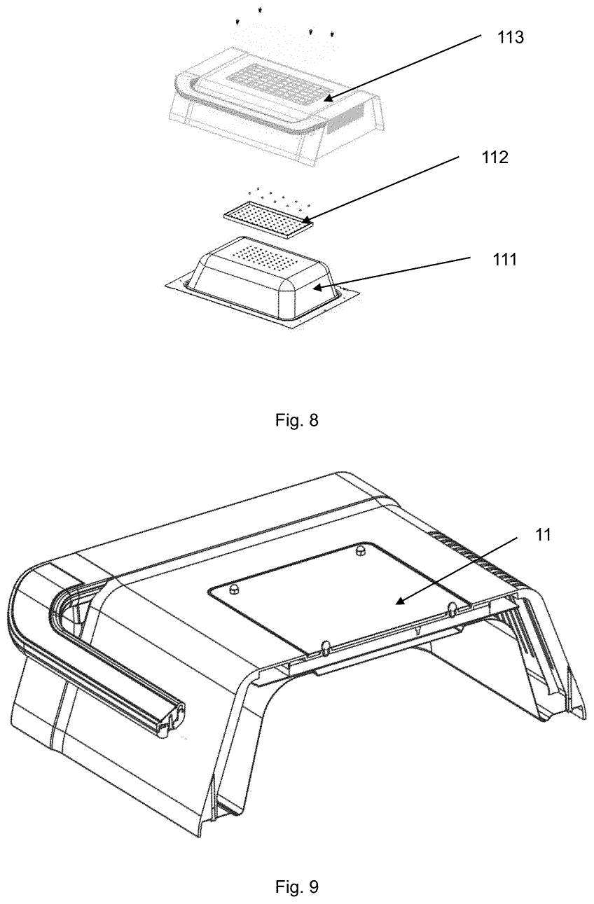

Referring to FIGS. 8 and 9, the oven lid 11 includes an oven lid inner casing 111 and an oven lid outer casing 113, and an oil-smoke absorption and decomposition device 112 is provided between the oven lid outer casing 113 and the oven lid inner casing 111. A photocatalytic mixture material is placed on the oil-smoke absorption and decomposition device 112 and can effectively remove the oil-smoke.

The present utility model also provides an oil-smoke adsorption rack, comprising a platform that generates oil-smoke and a frame disposed on the platform, wherein the aforementioned oil-smoke absorption and decomposition device is provided on the inner side of the frame, and the frames are distributed side by side on the platform, the frames having a distance of no more than 10 mm between them.

Likewise, in order to ensure the totality and stability of the oil-smoke removal, the oil-smoke absorption and decomposition device 4 is provided on the inner side of the frame, and the frames are arranged side by side on the platform with a distance of no more than 10 mm between them. The structure is simple and reasonable, and can effectively and totally remove the oil-smoke.

In summary, the present utility model discloses an oil-smoke removal device, including an oil-smoke removal device body, which is provided with an air inlet at one end and an air outlet at the other end, and an absorption and decomposition device for decomposing and absorbing the oil-smoke is provided in the middle of the oil-smoke removal device body. It is a structure mainly applied for absorbing oil-smoke during barbecue, and it uses the oil-smoke absorption and decomposition device in the structure to achieve the goal of effective adsorption and decomposition of the oil-smoke contained in the oil-smoke gas, which greatly reduces the environmental pollution caused by oil-smoke emissions, resulting in a very good effect in the practical application.

The embodiments of the present utility model are described above with reference to the attached drawings. However, the present utility model is not limited to the above specific embodiments. The above specific embodiments are merely illustrative and are not restrictive. Those of ordinary skill in the art may, without departing from the gist of the present utility model and the scope to be protected by the claims, make many forms in light of the present utility model, and these are all within the protection scope of the present utility model.

1. An oil-smoke removal device characterized in that the oil-smoke removal device comprises an oil-smoke removal device body, which is provided with an air inlet at one end, and an air outlet at the other end, and an absorption and decomposition device for decomposing and absorbing the oil-smoke being provided in the middle of the oil-smoke removal device body.

2. The oil-smoke removal device according to claim 1, further comprising a fan is provided in the middle of the oil-smoke removal device body, wherein the fan is disposed at the rear of the air inlet, and the absorption and decomposition device is located on both sides of the fan.

3. The oil-smoke removal device according to claim 1, wherein a UV-A ultraviolet lamp for activating the absorption and decomposition device is provided above or below the absorption and decomposition device.

4. The oil-smoke removal device according to claim 1, wherein the absorption and decomposition device is a photocatalytic mixture material of at least one layer.

5. The oil-smoke removal device according to claim 2, wherein the absorption and decomposition device is fixed in set to both sides of the fan by a fixing device.

6. The oil-smoke removal device according to claim 2, wherein the oil-smoke removal device body further comprises a stack disposed at the front end of the fan.

7. The oil-smoke removal device according to claim 6, wherein one end of the stack is connected to the fan, and the other end of the stack is close to but not contacting a barbecue platform.

8. The oil-smoke removal device according to claim 4, wherein the photocatalytic mixture material is provided with two layers, and the UV-A ultraviolet lamp is disposed in the middle of the photocatalytic mixture material.

9. The oil-smoke removal device according to claim 4, wherein the photocatalytic mixture material comprises a non-combustible absorbent and a photocatalytic material doped in the non-combustible absorbent.

10. The oil-smoke removal device according to claim 9, wherein the photocatalytic material comprises titanium dioxide.

11. The oil-smoke removal device according to claim 9, wherein the photocatalytic material further comprises one or more selected from the group consisting of silver ions, zinc ions, copper ions, and manganese ions.

12. The oil-smoke removal device according to claim 1, wherein the oil-smoke removal device further comprises a bracket disposed below the oil-smoke removal device.

13. The oil-smoke removal device according to claim 12, wherein one end of the bracket is connected to the oil-smoke removal device and the other end is detachably connected to the barbecue platform.

14. A barbecue device comprising a barbecue platform, wherein the oil-smoke removal device according to claim 1 is provided on the barbecue platform.

15. A barbecue oven, comprising an oven body for placing and processing barbecue materials and an oven lid coupled to the oven body, wherein the oil-smoke absorption and decomposition device according to claim 1 is provided on the oven lid.

16. The barbecue oven according to claim 15, wherein the oven lid and the oven body can be opened and closed to any angle and fixed.

17. The barbecue oven according to claim 15, wherein the maximum opening and closing angle between the oven body and the oven lid is 180°.

18. An oil-smoke adsorption rack, comprising a platform for producing oil-smoke and a frame on the platform, wherein the oil-smoke absorption and decomposition device according to claim 1 is provided on an inner side of the frame.

19. The oil-smoke adsorption rack according to claim 18, wherein the frames are distributed side by side on the platform.

20. The barbecue grill according to claim 18, wherein the distance between the frames is not greater than 10 mm.
